(19) United States
(12) Patent Application Publication
(10) Pub. No.: US 2013/0010995 A1
(43) Pub. Date: Jan. 10, 2013

(54) WELDING TYPE CONDENSER MICROPHONE USING SPRING BASE

(75) Inventors: Hyoung Joo KIM, Incheon (KR); Chang Won KIM, Incheon (KR); Myung Hoon HAM, Incheon (KR)

(73) Assignee: BSE CO., LTD., Incheon (KR)

(21) Appl. No.: 13/493,333

(22) Filed: Jun. 11, 2012

(30) Foreign Application Priority Data
Jul. 4, 2011 (KR) 10-2011-0066037

(51) Int. Cl. H04R 19/04

(52) U.S. Cl. 381/355

(57) ABSTRACT

A welding type condenser microphone using a spring base to prevent interferences due to deviations of thicknesses of components, wherein a second base is an elastic spring. The welding type condenser microphone includes a case sub-assembly, in which a diaphragm and a back plate face each other across a spacer in a metal case and the back plate is insulated from the case by a first base formed of an insulation material; a printed circuit board (PCB) sub-assembly, in which circuit devices and a second base, which is an elastic spring, are mounted on a PCB via a surface mounting technology (SMT) method; and a unit for attaching the case sub-assembly and the PCB sub-assembly to each other. Furthermore, the second base is a leaf spring that is bent once, a U-shaped leaf spring having wings, or a coil spring.

### CROSS-REFERENCE TO RELATED PATENT APPLICATION

This application claims the benefit of Korean Patent Application No. 10-2011-0066037, filed on Jul. 4, 2011, in the Korean Intellectual Property Office, the disclosure of which is incorporated herein in its entirety by reference

### BACKGROUND OF THE INVENTION

1. Field of the Invention

The present invention relates to a condenser microphone, and more particularly, to a welding type condenser microphone using a spring base to prevent interferences due to deviations of thicknesses of components, wherein a second base is an elastic spring.

2. Description of the Related Art

Generally, as shown in FIG. 1, a welding type condenser microphone 10 includes a metal case 11 having sound holes 11a formed in a front surface, a diaphragm 12, a spacer 13, a first ring-type base 14 formed of an insulator (also referred to as an insulation base), back plates 15 which faces the sound holes 11a formed in the front surface of the metal case 11 across the diaphragm 12 and the spacer 13, a second base 16 formed of a conductor (also referred to as a conductive base), and a printed circuit board (PCB) 17 on which circuit devices are mounted and connection terminals are formed, wherein the welding type condenser microphone 10 is manufactured by attaching (welding) an end of the case 11 to the PCB 17. Here, the case 11 and the PCB 17 may be attached to each other via laser welding, electric welding, soldering, or an attachment using a conductive adhesive.

### SUMMARY OF THE INVENTION

In a conventional welding type condenser microphone, compared to the case when a curling method is used, an attachment between components is weak, and thus, electric signals from a back plate and a diaphragm may not be transmitted to a printed circuit board (PCB) smoothly. In other words, an electric connection between a second base and a PCB may interfere with each other due to deviations of thicknesses of components which occur during fabrication of the components.

The present invention provides a welding type condenser microphone using a spring base which may prevent interferences due to deviations of thicknesses of components, wherein a second base as an elastic spring.

The present invention also provides a welding type condenser microphone using a spring base, in which a second base is mounted on a PCB via a surface mounting technology (SMT) method to simplify an assembly and obtain structural stability.

According to an aspect of the present invention, there is provided a welding type condenser microphone including a case sub-assembly, in which a diaphragm and a back plate face each other across a spacer in a metal case and the back plate is insulated from the case by a first base formed of an insulation material; a PCB sub-assembly, in is which circuit devices and a second base, which is an elastic spring, are mounted on a PCB via an SMT method; and a unit for attaching the case sub-assembly and the PCB sub-assembly to each other.

The second base may be a bent leaf spring, a U-shaped leaf spring having wings, or a coil spring.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view of a conventional welding type condenser microphone;

FIG. 2 is an exploded perspective view of a welding type condenser microphone according to an embodiment of the present invention;

FIG. 3 is a sectional view of the welding type condenser microphone according to an embodiment of the present invention;

FIG. 4 is an exploded perspective view of a second base of the welding type condenser microphone according to an embodiment of the present invention;

FIG. 5 is an exploded perspective view of a welding type condenser microphone according to another embodiment of the present invention;

FIG. 6 is a sectional view of the welding type condenser microphone according to another embodiment of the present invention;

FIG. 7 is an exploded perspective view of a second base used in another embodiment of the present invention;

FIG. 8 is an exploded perspective view of a welding type condenser microphone according to another embodiment of the present invention; and

FIG. 9 is a sectional view of the welding type condenser microphone according to another embodiment of the present invention.

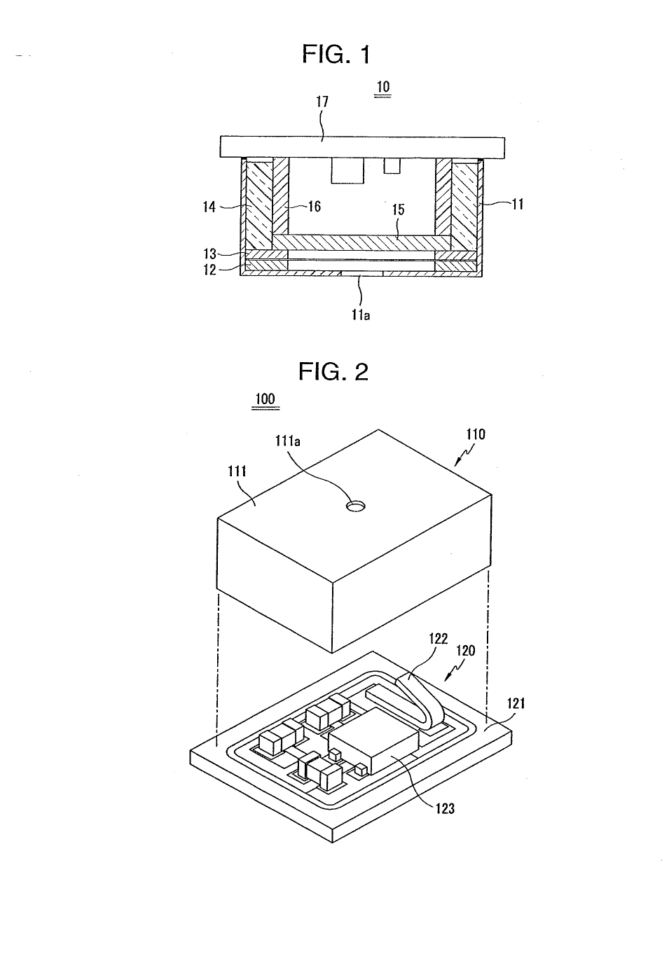

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein.

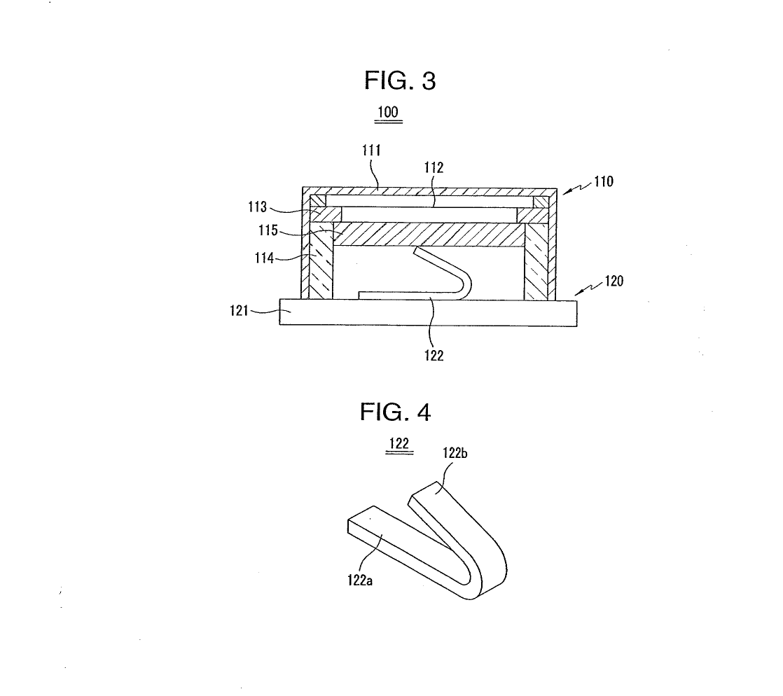

FIG. 2 is an exploded perspective view of a welding type condenser microphone 100 according to an embodiment of the present invention, FIG. 3 is a sectional view of the welding type condenser microphone 100 according to an embodiment of the present invention, and FIG. 4 is an exploded perspective view of a second base 122 of the welding type condenser microphone 100 according to an embodiment of the present invention.

As shown in FIGS. 2 through 4, in the welding type condenser microphone 100 according to the current embodiment of the present invention, a case sub-assembly 110, in which a diaphragm 112 and a back plate 115 face each other across a spacer 113 in a rectangular metal case 111 and the back plate 115 is insulated from the case 111 by a first base 114 formed of an insulation material, and a printed circuit board (PCB) sub-assembly 120, in which circuit devices 123 and the second base 122, which is a leaf spring that is bent once, are mounted on a rectangular PCB 121 via a surface mounting technology (SMT) method, are welded to each other to form a complete condenser microphone assembly.

Referring to FIGS. 2 through 4, sound holes 111a are formed in the rectangular metal case 111, and the diaphragm 112 is connected to the case 111 via a polar ring. When power is supplied, the diaphragm 112 and the back plate 115 face each other across a space formed by the spacer 113 and form a capacitance, wherein the back plate 115 is a back electret plate.

The circuit devices 123 mounted on the PCB 121 may include a field effect transistor (FET), a capacitor, a resistor, and the like. The circuit devices 123 apply a voltage to the diaphragm-back plate pair, amplify a change of a capacitance due to sound pressure applied from the outside, and output the amplified change of capacitance to an external circuit via connection terminals.

Furthermore, as shown in FIG. 4, the bottom surface 121a of the second base 122 mounted on the PCB 121 is adhered to the PCB 121 via an SMT method, and, since an elastic unit 122b, which is bent once, elastically presses the back plate 115 to closely contact the back plate 115, an electric connection between the back plate 115 and the PCB 121 is improved.

In the condenser microphone 100 according to the current embodiment of the present invention, since the diaphragm 112 is electrically connected to the PCB 121 via the metal case 111 and the second base 122 mounted on the PCB 121 via the SMT method transmits electric signals between the back plate 115 and the PCB 121, signals may be transmitted smoothly. Furthermore, even if interference due to deviations of thicknesses of components occurs, the second base 122 elastically contacts the back plate 115, and thus, a connection failure due to deviations of thicknesses of components may be resolved.

In the condenser microphone 100 according to the current embodiment of the present invention, when sound pressure is applied from the outside via the sound holes 111a of the case 111, the diaphragm 112 oscillates and the sound pressure is converted into electric signals according to a change of a distance between the back plate 115 and the diaphragm 112, the electric signals from the diaphragm 112 are transmitted to the PCB 121 via the metal case 111, the electric signals from the back plate 115 are transmitted to the PCB 121 via the second base 122, the electric signals are signal processed by the circuit devices 123 mounted on the PCB 121, and the processed signals are transmitted to the outside via connection terminals (not shown).

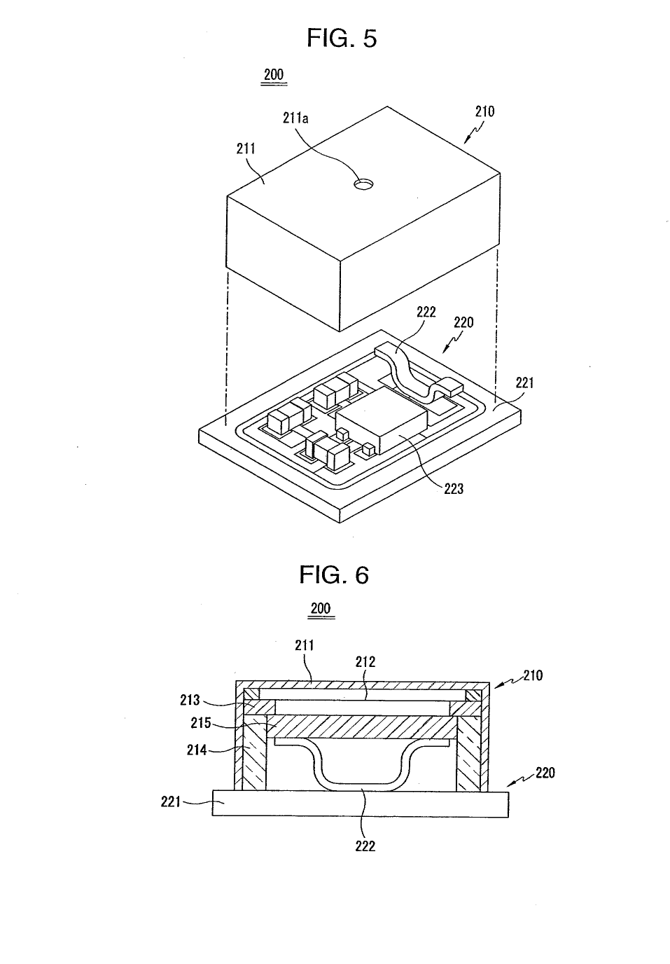

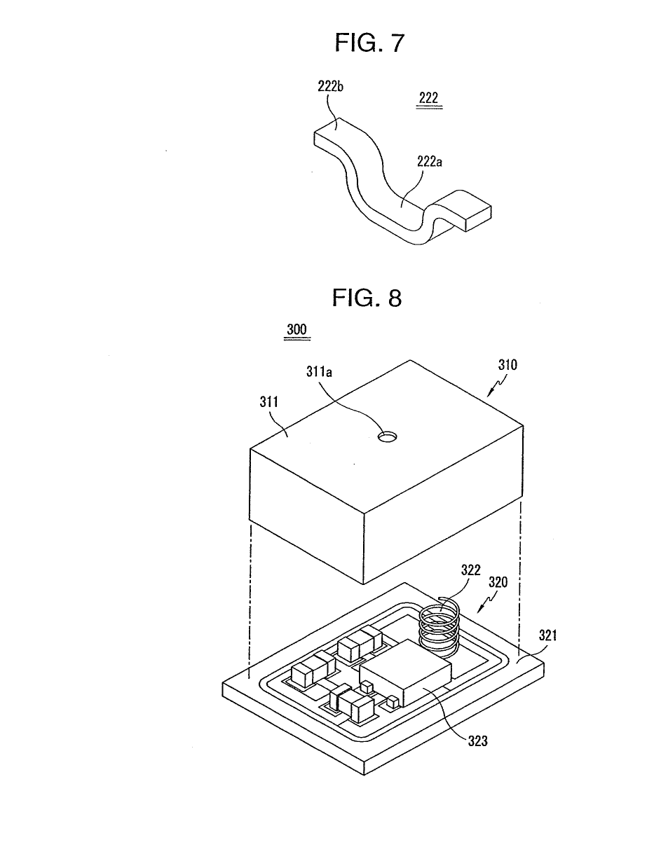

FIG. 5 is an exploded perspective view of a welding type condenser microphone 200 according to another embodiment of the present invention, FIG. 6 is a sectional view of the welding type condenser microphone according to another embodiment of the present invention, and FIG. 7 is an exploded perspective view of a second base 222 used in FIGS. 5 and 6, according to another embodiment of the present invention.

As shown in FIGS. 5 through 7, in the welding type condenser microphone 200 according to the current embodiment of the present invention, a case sub-assembly 210, in which a diaphragm 212 and a back plate 215 face each other across a spacer 213 in a rectangular metal case 211 and the back plate 215 is insulated from the case 211 by a first base 214 formed of an insulation material, and a PCB sub-assembly 220, in which circuit devices 223 and the second base 222, which is a U-shaped leaf spring having wings, are mounted on a rectangular PCB 221 via an SMT method, are welded to each other to form a complete condenser microphone assembly.

Referring to FIGS. 5 through 7, sound holes 211a are formed in the rectangular metal case 211, and the diaphragm 212 is connected to the case 211 via a polar ring. When power is supplied, the diaphragm 212 and the back plate 215 face each other is across a space formed by the spacer 213 and form a capacitance, wherein the back plate 215 is a back electret plate.

The circuit devices 223 mounted on the PCB 221 may include a FET, a capacitor, a resistor, and the like. The circuit devices 223 apply a voltage to the diaphragm-back plate pair, amplify a change of a capacitance due to sound pressure applied from the outside, and output the amplified change of capacitance to an external circuit via connection terminals.

Furthermore, as shown in FIG. 7, the second base 222 is a U-shaped leaf spring having wings 222b and the bottom surface 221a of the second base 222 mounted on the PCB 221 is adhered to the PCB 221 via an SMT method, wherein, since the wings 222b elastically press the back plate 215 to closely contact the back plate 215, an electric connection between the back plate 215 and the PCB 221 is improved.

In the condenser microphone 200 according to the current embodiment of the present invention, since the diaphragm 212 is electrically connected to the PCB 221 via the metal case 211 and the second base 222 mounted on the PCB 221 via the SMT method transmits electric signals between the back plate 215 and the PCB 221, signals may be transmitted smoothly. Furthermore, even if interference due to deviations of thicknesses of components occurs, the second base 222 elastically contacts the back plate 215, and thus, a connection failure due to deviations of thicknesses of components may be resolved.

In the condenser microphone 200 according to the current embodiment of the present invention, when sound pressure is applied from the outside via the sound holes s 211a of the case 211, the diaphragm 212 oscillates and the sound pressure is converted into electric signals according to a change of a distance between the back plate 215 and the diaphragm 212, the electric signals from the diaphragm 212 are transmitted to the PCB 221 via the metal case 211, the electric signals from the back plate 215 are transmitted to the PCB 221 via the second base 222, the electric signals are signal processed by the circuit devices 223 mounted on the PCB 221, and the processed signals are transmitted to the outside via connection terminals (not shown).

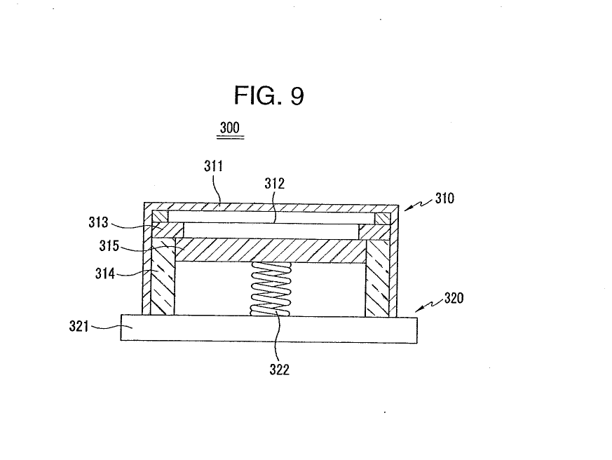

FIG. 8 is an exploded perspective view of a welding type condenser microphone 300 according to another embodiment of the present invention, and FIG. 9 is a sectional view of the welding type condenser microphone 300 according to another embodiment of the present invention.

As shown in FIGS. 8 and 9, in a welding type condenser microphone 300 according to the current embodiment of the present invention, a case sub-assembly 310, in which a diaphragm 312 and a back plate 315 face each other across a spacer 313 in a rectangular metal case 311 and the back plate 315 is insulated from the case 311 by a first base 314 formed of an insulation material, and a PCB sub-assembly 320, in which circuit devices 323 and a second base 322, which is a coil spring, are mounted on a rectangular PCB 321 via an SMT method, are welded to each other to form a complete condenser microphone assembly.

Referring to FIGS. 8 and 9, sound holes 311a are formed in the rectangular metal case, and the diaphragm 312 is connected to the case 311 via a polar ring. When power is supplied, the diaphragm 312 and the back plate 315 face each other across a space formed by the spacer 313 and form a capacitance, wherein the back plate 315 is a back electret plate.

The circuit devices 323 mounted on the PCB 321 may include a FET, a capacitor, a resistor, and the like. The circuit devices 323 apply a voltage to the diaphragm-back plate pair, amplify a capacitance change due to sound pressure applied from the outside, and output the amplified capacitance change to an external circuit via connection terminals.

The condenser microphone 300 according to the current embodiment of the present invention is identical to those of the above embodiments, except that the second base 312 is a coil spring. Therefore, further descriptions will be omitted.

A welding type condenser microphone according to the present invention may resolve interference due to deviations of thicknesses of components by applying a second base as a spring with elasticity. Furthermore, an assembly of the microphone may be simplified and a structure of the microphone may be stable by mounting a second base on a PCB via an SMT method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A welding type condenser microphone using a spring base, the welding type condenser microphone comprising:
a case sub-assembly, in which a diaphragm and a back plate face each other across a spacer in a metal case and the back plate is insulated from the case by a first base formed of an insulation material;
a printed circuit board (PCB) sub-assembly, in which circuit devices and a second base, which is an elastic spring, are mounted on a PCB via a surface mounting technology (SMT) method; and
a unit for attaching the case sub-assembly and the PCB sub-assembly to each other.

2. The welding type condenser microphone of claim 1, wherein the second base is a bent leaf spring.

3. The welding type condenser microphone of claim 1, wherein the second base is a U-shaped leaf spring having wings, and
the bottom surface of the second base is attached to the PCB.

4. The welding type condenser microphone of claim 1, wherein the second base is a coil spring.
